(19) United States
(12) Patent Application Publication
(10) Pub. No.: US 2006/0047076 A1
(43) Pub. Date: Mar. 2, 2006

(54) Solid state modification of multimodal polyethylene

(76) Inventor: Andrew J. Scheie, Cincinnati, OH (US)

Correspondence Address: LYONDELL CHEMICAL COMPANY, 3801 WEST CHESTER PIKE, NEWTOWN SQUARE, PA, 19073, US

(21) Appl. No.: 10/930,295

(22) Filed: Aug. 31, 2004

(51) Int. Cl. C08L 23/04

(52) U.S. Cl. 525/240

(57) ABSTRACT

A method for modifying multimodal polyethylene is disclosed. The method comprises reacting a multimodal polyethylene in its solid state with a free radical initiator. The modified polyethylene has significantly increased melt strength, and it is suitable for many applications including blow molding, sheet, pipe, profile, extrusion coating, and foaming applications.

### FIELD OF THE INVENTION

The invention relates to polyethylene modification. More particularly, the invention relates to solid state modification of multimodal polyethylene.

### BACKGROUND OF THE INVENTION

Multimodal polyethylenes are known. Multimodal polyethylenes are those which comprise two or more polyethylene components. Each component has a different molecular weight. Thus, multimodal polyethylenes usually have a broad molecular weight distribution. They often show two or more peak molecular weights on gel permeation chromatography (GPC) curves. Multimodal polyethylenes are commonly made with Ziegler catalysts by multistage or multi-reactor processes. They are widely used in film applications because of their excellent processability. See U.S. Pat. No. 5,962,598.

However, multimodal polyethylenes made with Ziegler catalysts have limited uses in blow molding applications because they have high die swell and lack sufficient melt strength. This lack of melt strength also limits their use in sheet, pipe, profile, extrusion coating, and foaming applications. Extrusion oxidation or peroxidation can reduce die swell and increase melt strength of multimodal polyethylene. However, extrusion oxidation or peroxidation is difficult to control and often causes gel formation.

New methods for modifying multimodal polyethylene are needed. Ideally, the modification would be performed without using extrusion and produce modified polymer essentially gel free.

### SUMMARY OF THE INVENTION

The invention is a method for modifying multimodal polyethylenes. The method comprises reacting a free radical initiator with a multimodal polyethylene in its solid state. By “solid state,” I mean that the reaction is performed at a temperature below the melting point of the polyethylene. The modified polyethylene has reduced die swell and increased melt strength. They are suitable for blow molding, sheet, pipe, profile, film, extrusion coating, and foaming applications. Unlike the extrusion oxidation known in the art, the method of the invention provides a modified polyethylene without gel formation.

### DETAILED DESCRIPTION OF THE INVENTION

The invention is a method of modifying a multimodal polyethylene. By “multimodal,” I mean any polyethylene which comprises two or more polyethylene components that vary in molecular weight. Preferably, the polyethylene has more than one molecular weight peaks on GPC (gel permeation chromatography) curve.

Suitable multimodal polyethylene includes high density polyethylene (HDPE), medium density polyethylene (MDPE), low density polyethylene (LDPE), and linear low density polyethylene (LLDPE). HDPE has a density of 0.941 g/cm³ or greater; MDPE has density from 0.926 to 0.940 g/cm³; and LDPE or LLDPE has a density from 0.910 to 0.925 g/cm³. See ASTM D4976-98: Standard Specification for Polyethylene Plastic Molding and Extrusion Materials. Preferably, the multimodal polyethylene is an HDPE. Density is measured according to ASTM D1505.

Preferably, the multimodal polyethylene is a bimodal polyethylene. By “bimodal,” I mean that the polyethylene which comprises two components. Preferably, the lower molecular weight component has a melt index (MI₂) within the range of about 10 dg/min to about 750 dg/min, more preferably from about 50 dg/min to about 500 dg/min, and most preferably from about 50 dg/min to about 250 dg/min. Preferably, the higher molecular weight component has an MI₂ within the range of about 0.0005 dg/min to about 0.25 dg/min, more preferably from about 0.001 dg/min to about 0.25 dg/min, and most preferably from about 0.001 dg/min to about 0.15 dg/min. MI₂ is measured according to ASTM D-1238.

Preferably, the lower molecular weight component of the bimodal polyethylene has a higher density than the higher molecular weight component. Preferably, the lower molecular weight component has a density within the range of about 0.925 g/cm³ to about 0.970 g/cm³, more preferably from about 0.938 g/cm³ to about 0.965 g/cm³, and most preferably from about 0.940 g/cm³ to about 0.965 g/cm³. Preferably, the higher molecular weight component has a density within the range of about 0.865 g/cm³ to about 0.945 g/cm³, more preferably from about 0.915 g/cm³ to about 0.945 g/cm³, and most preferably from about 0.915 g/cm³ to about 0.945 g/cm³.

Preferably, the bimodal polyethylene has a lower molecular weight component/higher molecular weight component weight ratio within the range of about 10/90 to about 90/10, more preferably from 20/80 to 80/20, and most preferably from about 35/65 to about 65/35.

Multimodal polyethylene preferably has a weight average molecular weight (Mw) within the range of about 50,000 to about 1,000,000. More preferably, the Mw is within the range of about 100,000 to about 500,000. Most preferably, the Mw is within the range of about 150,000 to about 350,000. Preferably, the multimodal polyethylene has a number average molecular weight (Mn) within the range of about 5,000 to about 100,000, more preferably from about 10,000 to about 50,000. Preferably, the multimodal polyethylene has a molecular weight distribution (Mw/Mn) greater than 8, more preferably greater than 10, and most preferably greater than 15.

Multimodal polyethylene can be made by blending a higher molecular weight polyethylene with a lower molecular weight polyethylene. Alternatively, multimodal polyethylene can be made by a multiple reactor process. The multiple reactor process can use either sequential multiple reactors or parallel multiple reactors, or a combination of both. For instance, a bimodal polyethylene can be made by a sequential two-reactor process which comprises making a lower molecular weight component in a first reactor, transferring the lower molecular weight component to a second reactor, and making a higher molecular weight component in the second reactor. The two components are blended in-situ in the second reactor.

Alternatively, a bimodal polyethylene can be made by a parallel two-reactor process which comprises making a lower molecular weight component in a first reactor and making a higher molecular weight component in a second reactor, and blending the components in a mixer. The mixer can be a third reactor, a mixing tank, or an extruder.

Ziegler, single-site, and multiple catalyst systems can be used to make multimodal polyethylene. For instance, U.S. Pat. No. 6,127,484, the teachings of which are incorporated herein by reference, teaches a multiple catalyst process. A single-site catalyst is used in a first stage or reactor, and a Ziegler catalyst is used in a later stage or a second reactor. The single-site catalyst produces a polyethylene having a lower molecular weight, and the Ziegler catalyst produces a polyethylene having a higher molecular weight. Therefore, the multiple catalyst system can produce bimodal or multimodal polymers. Preferably, the multimodal polyethylene is made with Ziegler catalysts.

Preferably, the multimodal polyethylene is in powder form with an average particle size less than 250 microns. More preferably, the particle size is within the range of about 50 microns to about 150 microns. Most preferably, the particle size is within the range of about 80 microns to about 100 microns.

Suitable free radical initiators include those known in the polymer industry. They include peroxides, hydroperoxides, peresters, and azo compounds. Peroxides are preferred. Examples of suitable free radical initiators are dicumyl peroxide, di-t-butyl peroxide, t-butylperoxybenzoate, 2,5-dimethyl-2,5-di(t-butylperoxy)hexane, t-butyl peroxyneodecanoate, 2,5-dimethyl-2,5-di(t-butylperoxy)hexyne, t-amyl peroxypivalate, 1,3-bis(t-butylperoxyisopropyl)benzene, the like, and mixtures thereof. Preferably, the initiator has a decomposition temperature below the melting point of the multimodal polyethylene.

Preferably, the free radical initiator is used in an amount within the range of about 1 ppm to about 4,500 ppm of the multimodal polyethylene. More preferably, the amount of initiator is within the range of about 2 ppm to about 500 ppm of the multimodal polyethylene. Most preferably, the amount of initiator is within the range of about 2 ppm to about 200 ppm of the multimodal polyethylene.

The free radical initiator is mixed with the multimodal polyethylene. Mixing is preferably performed at a temperature which is below the decomposition temperature of the initiator. Mixing can be performed with any suitable methods.

The reaction time varies depending on many factors such as temperature, initiator type and amount, and particle size of the multimodal polyethylene. Typically, the reaction time is several times of the initiator half-life.

The reaction temperature is below the melting point of the polyethylene so that the reaction occurs in the solid state of the polyethylene. Preferably, the reaction is performed at a temperature within the range of about 50° C. to about 120° C. More preferably, the reaction is performed at a temperature within the range of about 60° C. to about 100° C.

Preferably, the reaction is performed within the polyethylene manufacture process. For instance, in a slurry polyethylene production line, polyethylene slurry from the reactor is sent to a flash drum wherein the solvent and unreacted monomers are removed and a polyethylene powder is obtained. The powder is then dried through one or more driers and then sent to an extruder to pelletize. Preferably, the free radical initiator and the polyethylene can be mixed and reacted between the points of the flash drum and the pelletizer. For instance, the free radical initiator can be mixed with the polyethylene powder in the flash drum and the reaction can be performed in the driers. By doing so, there will be minimum production time and cost added.

The invention includes the modified multimodal polyethylene. The modified multimodal polyethylene has reduced die swell and increased melt strength. Additionally, the modified multimodal polyethylene is essentially gel free. The modified multimodal polyethylene can be used in any applications where high melt strength is desirable, including films, sheets, pipes, profile, extrusion coating, foaming, and blow molding. The modified multimodal polyethylene is particularly useful for blow molding applications for its reduced die swell.

The increased melt strength of the modified polyethylene is evidenced by a noticeable upturn at low frequencies in their dynamic rheological data. By upturn, I mean that the dynamic complex viscosity (η*) increases with decreasing frequencies at frequencies of less than about 1.0 rad/sec. In contrast, the ethylene polymer base resins generally exhibit a limiting constant value at frequencies of about <0.1 rad/sec. The relative increase in complex viscosity as compared to the base resin is expressed by the ratio of complex viscosity of the modified polyethylene to the base resin at a frequency of 0.0251 radians/second.

As will be recognized by those skilled in the art, specific complex viscosity ratios referred to herein are provided only to demonstrate the viscosity upturn, i.e., melt strength increase, obtained for the polyethylene of the invention and are not intended to be limiting since they are generated under a specific set of conditions. Rheological data generated using different conditions, e.g., temperature, percent strain, plate configuration, etc., could result in complex viscosity ratio values which are higher or lower than those recited in the specification and claims which follow.

The following laboratory examples merely illustrate the invention. Those skilled in the art will recognize many variations that are within the spirit of the invention and scope of the claims.

### EXAMPLE 1

### Solid State Modification

Reactor powder of commercial bimodal, high density polyethylene (L5440, product of Equistar Chemical, LP, density: 0.954 g/cm³, melt index (MI₂): 0.35 dg/min, melting point: 131° C.) is mixed with 100 ppm of 2,5-dimethyl-2,5-di(t-butylperoxy)hexane at 25° C. The mixture is placed in an oven at 105° C. for 6 hours. The modified polyethylene exhibits a substantial increase in melt strength over the L5440 base resin. The η ratio at 0.0251 radians/second is 1.36. The modified polymer has a 256% of die swell at 1025/sec shear rate, 190° C.

Rheological properties are determined using a Rheometrics ARES rheometer. Rheological data are generated by measuring dynamic rheology in the frequency sweep mode to obtain complex viscosities (η*), storage modulus (G′) and loss modulus (G″) for frequencies ranging from 0.0251 to 398 rad/sec for each composition. The rheometer is operated at 190° C. in the parallel plate mode (plate diameter 25 mm) in a nitrogen environment (in order to minimize sample oxidation/degradation). The gap in the parallel plate geometry is 1.2-1.4 mm and the strain amplitude is 20%. Rheological properties are determined using standard test procedure ASTM D 4440-84. Die swell is a measure of the diameter extrudate relative to the diameter of the orifice from which it is extruded. Value reported is obtained using an Instron 3211 capillary rheometer fitted with a capillary of diameter 0.0301 inches and length 1.00 inches.

### EXAMPLE 2

### Solid State Modification

Reactor powder of L5440 is modified with 5 ppm of 2,5-dimethyl-2,5-di(t-butylperoxy)hexane under the same conditions as above. The η* ratio at 0.0251 radians/second is 1.47.

### COMPARATIVE EXAMPLE 3

### Non-Modified Control

Reactor powder of L5440 is tested for die swell under the same condition as described in Example 1. The die swell value is 282%. This non-modified resin may not be suitable for certain blow molding applications because its die swell value is too high.

### COMPARATIVE EXAMPLE 4

### Conventional Extrusion Oxidation

The polyethylene/initiator mixture of Example 1 is oxidized in an extruder. The oxidized resin is tested for melt strength under the same condition as described in Example 1. Its viscosity ratio is 1.14, which indicates that the solid state modification of the invention is much more efficient in increasing melt strength than the conventional extrusion modification.

### COMPARATIVE EXAMPLE 5

### Chromium Blow Molding Polyethylene

A commercial blow molding polyethylene made by chromium catalyst (LR7320, product of Equistar) is tested for die swell under the same condition as described in Example 1. Its die swell value is 271%, which shows that the solid state modification of the invention may provide even lower die swell than the commercial chromium resin.

### EXAMPLE 6

### Bottle Properties

Bottles are made by a blow molding process from the modified resin of Example 1, the conventionally modified resin of Comparative Example 4, and the chromium resin of Comparative 5; the average bottle weights for the same bottle size are 52.4 g, 60.7 g, and 60 g, respectively. These results indicate the modified polyethylene of Example 1 provides thinner bottles than the conventional extrusion oxidized resin of Comparative Example 4 and the chromium resin of Comparative Example 5.

I claim:

1. A method comprising reacting a multimodal polyethylene with a free radical initiator at a temperature below the melting point of the polyethylene.

2. The method of claim 1 wherein the polyethylene is a powder having an average particle size less than 250 microns.

3. The method of claim 2 wherein the average particle size is within the range of about 50 microns to about 150 microns.

4. The method of claim 2 wherein the average particle size is within the range of about 80 microns to about 100 microns.

5. The method of claim 1 wherein the free radical initiator is a peroxide.

6. The method of claim 1 wherein the free radical initiator is used in an amount within the range of about 2 ppm to about 200 ppm of the multimodal polyethylene.

7. The method of claim 1 wherein the multimodal polyethylene is produced by a Ziegler catalyst.

8. The method of claim 1 wherein the multimodal polyethylene comprises a lower molecular weight component having a melt index (MI₂) within the range of about 10 dg/min to about 750 dg/min and a higher molecular weight component having an MI₂ within the range of about 0.0005 dg/min to about 0.25 dg/min.

9. The method of claim 8 wherein the multimodal polyethylene has a lower molecular weight component/higher molecular weight component weight ratio within the range of about 10/90 to about 90/10.

10. The method of claim 8 wherein the lower molecular weight component has a density within the range of about 0.925 g/cm³ to about 0.970 g/cm³ and the higher molecular weight component has a density within the range of about 0.865 g/cm³ to about 0.945 g/cm³.

11. The method of claim 8 wherein the multimodal polyethylene is made by a process which comprises making a lower molecular weight component in a first reactor, transferring the lower molecular weight component to a second reactor and making a higher molecular weight component therein.

12. The method of claim 1 wherein the temperature is within the range of about 50° C. to about 120° C.

13. The method of claim 1 wherein the temperature is within the range of about 60° C. to about 100° C.

14. The method of claim 1 wherein the resultant polyethylene has an increased melt strength.

15. A multimodal polyethylene modified by the method of claim 1.
